(19) United States
(12) Patent Application Publication
(10) Pub. No.: US 2002/0184920 A1
(43) Pub. Date: Dec. 12, 2002

(54) Method and system for producing ornamental glass strips and similar

(75) Inventor: Claudio Fossaluzza, Mogliano Veneto (IT)

Correspondence Address: William R. Evans, Ladas & Parry, 26 West 61 Street, New York, NY, 10023, US

(73) Assignee: CERAMGRES S.R.L.

(21) Appl. No.: 10/141,521

(22) Filed: May 7, 2002

(30) Foreign Application Priority Data
May 8, 2001 (IT) BO2001A000282

(51) Int. Cl. C03B 33/00

(52) U.S. Cl. 65/60.8; 65/112; 65/61

(57) ABSTRACT

A method of producing ornamental glass strips and similar, and which includes the steps of shaping, by removing material, at least one surface portion of a glass bar, so as to impart to the glass bar the profile of the ornamental glass strip to be produced; and baking the glass bar at a predetermined temperature for a predetermined length of time.

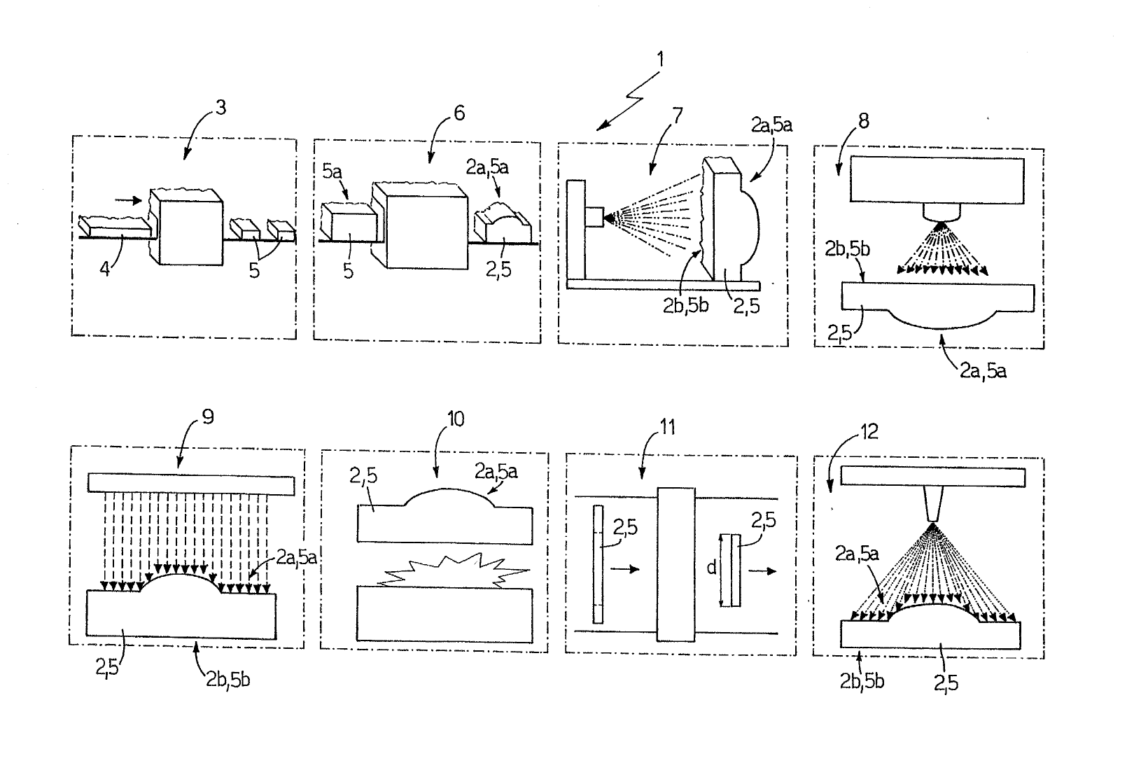

The present invention relates to a method of producing ornamental glass strips and similar.

More specifically, the present invention relates to a method of producing ornamental glass strips and similar for covering and/or ornamenting floors, walls, or ceilings; to which application the following description refers purely by way of example.

### BACKGROUND OF THE INVENTION

As is known, currently used methods of producing ornamental glass strips substantially comprise pouring a given quantity of molten glass into molds negatively reproducing the shape of the strip to be produced; and then polishing the strip when cooled.

Unfortunately, ornamental glass strips produced using the above method are of poor quality, i.e. fail to meet market requirements and standards in terms of surface finish and shine.

Moreover, the above method is extremely expensive and unsuitable for mass production by failing to ensure a high output rate.

### SUMMARY OF THE INVENTION

It is an object of the present invention to provide a method of producing ornamental glass strips and similar, which is straightforward and cheap to implement, and, at the same time, provides for eliminating the aforementioned drawbacks.

According to the present invention, there is provided a method of producing ornamental glass strips, characterized by comprising the steps of shaping, by removing material, at least one surface portion of a glass bar, so as to impart to the glass bar the profile of the ornamental glass strip to be produced; and baking said glass bar at a predetermined temperature for a predetermined length of time.

According to the present invention, there is also provided a system for producing ornamental glass strips, characterized by comprising shaping means for removing glass from at least one surface portion of a glass bar, so as to impart to the glass bar a predetermined ornamental profile; and baking means for heat treating said glass bar.

### BRIEF DESCRIPTION OF THE DRAWING

The present invention will be described with reference to the accompanying drawing, which shows, schematically, a system for producing ornamental glass strips in accordance with the teachings of the present invention.

### DETAILED DESCRIPTION OF THE INVENTION

Number 1 in the accompanying drawing indicates as a whole a system for producing ornamental glass strips 2 and similar, preferably, though not necessarily, for covering and/or ornamenting floors, walls, and ceilings.

System 1 comprises a glass-cutting station 3, where a glass sheet 4 of given thickness is cut into a succession of glass bars 5; a shaping station 6, where each bar 5 is shaped to assume a given ornamental profile; and a painting station 7, where a chemical coloring product, described in detail later on, is applied to each bar 5.

System 1 also comprises a drying station 8, where the coloring product applied to each bar 5 is dried and so fixed to the surface of bar 5; and an enameling station 9, where a known chemical glass-processing product, described in detail later on, is applied to the outer surface of bar 5.

System 1 also comprises a baking station 10, where each bar 5 is subjected to a predetermined baking process described in detail later on; and a trimming station 11, where the two axial ends of bar 5 deformed by the baking process are cut off.

Preferably, though not necessarily, system 1 also comprises a satin-finish station 12, where each bar 5 is subjected to a mechanical or chemical process to obtain an opaque, satiny outer surface.

In the particular example shown, glass-cutting station 3 is defined by a known glass-cutting machine having a diamond cutting tool for fully automatically cutting glass sheet 4 into a succession of substantially rectangular-section bars 5; and shaping station 6 is defined by a marble- and granite-beveling machine appropriately modified to remove glass from the front surface 5a of bars 5 and impart to the bars a predetermined ornamental profile.

More specifically, in the example shown, shaping station 6 is defined by a conventional marble- and granite-beveling machine, on which the marble diamond cutters are replaced with glass diamond cutters (not shown).

In the example shown, painting station 7 is defined by a known silkscreen machine for applying, using the silkscreen method, a chemical coloring product coating to the rear surface 5b of bar 5, i.e. to the concealed surface 2b of ornamental strip 2. The silkscreen machine may obviously be combined or replaced with a known painting machine for spraying on the coloring product.

The chemical coloring product applied at painting station 7 may be, for example, a glass-fusion color, colored enamel, ceramic pigment, finely ground glass grit, or a combination of two or more of the above products.

It should be pointed out that, as an alternative to the silkscreen and/or painting machine, the chemical coloring product coating may also be applied manually using brushes, sponges, or similar.

With reference to the accompanying drawing, drying station 8 and baking station 10 may advantageously be defined by a known ventilated hot-air drying furnace and a known single-layer gas furnace respectively.

Enameling station 9 is defined by an enameling machine for spraying the surface of bar 5 ground at shaping station 6, i.e. the front surface 5a of bar 5, with a coating of antidevitrification enamel generally comprising a mixture of “frits”, i.e. sand and alkaline substances normally used for ceramic enamel.

The antidevitrification enamel is preferably, though not necessarily, transparent, and has always been traditionally used in glassmaking to prevent dulling of the colored surface of enameled glass articles subjected to particularly severe heat treatment.

It should be pointed out, however, that, in this context, the antidevitrification enamel is not used, as traditionally, to preserve the shine (i.e. prevent devitrification) of the glass surface of bar 5—seeing as the surface to which the antidevitrification enamel is applied is not coated beforehand with any colored enamel or other pigment whose shine needs preserving—but rather to restore the glass surface (front surface 5a) of bar 5 spoilt by machining at shaping station 6.

Tests have shown, in fact, that, if subjected to a given heat treatment, antidevitrification enamel is capable of fully restoring and eliminating any unevenness of the glass surface, i.e. front surface 5a, of bar 5 spoilt by machining at shaping station 6.

It should be stressed that the ability of antidevitrification enamel to fully restore the machined glass surface was totally unknown till now.

In the example shown, the antidevitrification enamel preferably, though not necessarily, comprises a mixture containing from 3.30 to 3.90% of cadmium compounds, and from 52 to 57% of lead compounds. More specifically, the example shown employs an antidevitrification enamel known as KEMOIL F133/318 marketed by the Italian company CHEM COLOR S.a.S., or products 438, 437 and 442 marketed by the Italian company CERDEC ITALIA S.p.A.

In the example shown, trimming station 11 is defined by a conventional machine with a rotary cutter for cutting off pieces of glass; and satin-finish station 12 is defined by a sanding machine for blasting and evenly abrading the surface of bar 5 with corundum powder or similar, to obtain an opaque, satiny surface of bar 5.

The rotary-cutter machine defining trimming station 11, the sanding machine defining satin-finish station 12, the glass-cutting machine defining glass-cutting station 3, the silkscreen machine defining painting station 7, the ventilated hot-air drying furnace defining drying station 8, the enameling machine defining enameling station 9, and the single-layer gas furnace defining baking station 10, are all widely used in the industry and therefore not described in detail. And the same obviously also applies to the marble- and granite-beveling machine defining shaping station 6, the only alteration to which with respect to conventional machines is replacement of the marble diamond cutters with diamond cutters specially designed for cutting glass.

Operation of system 1 as defined above will be described with reference to one substantially rectangular-section bar 5 of transparent glass.

At cutting station 3, a sheet 4 of transparent glass is cut into a number of glass bars 5 defining “blank” ornamental glass strips 2, i.e. with no ornamental profile or coloring.

Once cut off sheet 4, bar 5 is fed to shaping station 6, where the beveling machine machines the front surface 5a of bar 5, i.e. the front surface 2a of ornamental strip 2, to a given ornamental profile.

The shaped bar 5 is then fed to painting station 7, where the silkscreen machine applies a coating of a chemical coloring product to the rear surface 5b of bar 5, i.e. to the concealed rear surface 2b of ornamental strip 2.

As stated, painting may also be performed manually using, for example, brushes or sponges; in which case, system 1 has no silkscreen machine.

The painted bar 5 is then fed to drying station 8, where, for a given length of time, the ventilated hot-air drying furnace brings the surface of bar 5 to a given temperature, preferably, though not necessarily, ranging between 90° C. and 110° C., so as to dry and fix the chemical coloring product to the rear surface 5b of bar 5.

When the chemical coloring product is dry, bar 5 is fed to enameling station 9, where antidevitrification enamel is applied to the front surface 5a of bar 5 shaped on the beveling machine, i.e. front surface 2a of ornamental strip 2.

Once the antidevitrification enamel is applied, bar 5 is fed to baking station 10 and into the single-layer gas furnace, where, for a given length of time—preferably, though not necessarily, 80 to 100 minutes—bar 5 is brought to a given baking temperature close to “glass softening temperature” and preferably, though not necessarily, ranging between 800° C. and 850° C.

In the single-layer gas furnace, the antidevitrification enamel covering front surface 5a of bar 5 combines, by a process of glass fusion, with the surface glass layer of bar 5 close to softening temperature, so as to restore the original surface structure, shine, and transparency of front surface 5a of bar 5, and at the same time eliminate any cracks produced when shaping bar 5.

It should be pointed out that baking time and temperature are established as a function of the type of strip being produced and the type of glass it is made of, so as to avoid excessively straining ornamental strip 2.

It should also be pointed out that glass bar 5 is baked in the single-layer gas furnace resting on a supporting panel for preventing bar 5 from buckling during the baking process, and so ensuring it is perfectly straight when it comes out of the furnace; which supporting panel is preferably, though not necessarily, defined by a sheet of known soluble glass fiber or known ceramic fiber.

At the end of the baking stage, bar 5 is fed to trimming station 11, where the two axial ends of bar 5 deformed excessively during baking are removed. In the example shown, trimming comprises cutting glass bar 5 to remove an end portion of normally 2 to 3 cm in length.

Once trimmed, bars 5 are all of the same section, axial length d, and surface finish, and so define ornamental strips 2 ready for use.

To produce ornamental strips 2 with a satiny surface finish, the method described above comprises, after trimming, transferring bar 5, i.e. the glossy ornamental strip 2, to satin-finish station 12, where bar 5 is abraded by sanding to produce an opaque, satiny outer surface of bar 5, i.e. of ornamental strip 2.

In the method described above, in addition to or instead of the sanding machine stage, application of the antidevitrification enamel at enameling station 9 may be replaced by spraying at least front surface 5a of bar 5 with a dulling enamel, which, when baked, produces an evenly opaque, satiny surface finish of bar 5.

The dulling enamel referred to is of known type, and preferably, though not necessarily, comprises a mixture containing 1.30 to 1.90% of cadmium compounds, and 6.8 to 7.8% of lead compounds.

More specifically, in the example shown, a dulling enamel known as KEMOIL SATINATO S433/318, marketed by CHEM COLOR S.a.S., is used.

As stated, satin-finishing of ornamental strip 2 may be completed at satin-finish station 12, by feeding the ornamental strip 2 from trimming station 11 to the sanding machine.

To conclude, it should be pointed out that the production method implemented by system 1 may also be used for producing ornamental strips 2 of colored glass; in which case, the starting bar 5 is made of colored glass, so that painting and drying the rear surface 5b of bar 5, and therefore the relative stations in system 1, are no longer required.

The method and system for producing ornamental glass strips and similar as described and illustrated herein have the big advantage of producing ornamental glass strips 2 of superior aesthetic quality and at low cost.

Moreover, the method of producing ornamental glass strips is easy to implement, by system 1 comprising commonly used glass and marble machining equipment.

It should also be pointed out that the method provides for producing ornamental strips 2 of any color and shape to meet any consumer requirements.

Clearly, changes may be made to the method as described and illustrated herein without, however, departing from the scope of the present invention.

1. A method of producing ornamental glass strips (2), characterized by comprising the steps of:
shaping, by removing material, at least one surface portion (5a) of a glass bar (5), so as to impart to the glass bar the profile of the ornamental glass strip (2) to be produced; and
baking said glass bar (5) at a predetermined temperature for a predetermined length of time.

2. A method as claimed in claim 1, characterized by comprising the step of cutting a portion of predetermined length off the two ends of said glass bar (5) after said baking step.

3. A method as claimed in claim 1, characterized by comprising the step of applying a chemical glass-processing product to at least said shaped portion (5a) of said glass bar (5), prior to said step of baking the glass bar (5).

4. A method as claimed in claim 3, characterized in that said chemical glass-processing product is an antidevitrification enamel for restoring said shaped portion (5a) of said glass bar (5).

5. A method as claimed in claim 3, characterized in that said chemical glass-processing product is a dulling enamel for imparting a satiny finish to said shaped portion (5a) of said glass bar (5).

6. A method as claimed in claim 1, characterized by comprising the step of applying a chemical coloring product to a surface portion (5b) of said glass bar (5).

7. A method as claimed in claim 6, characterized by comprising the step of drying said chemical coloring product on said glass bar (5) after said step of applying said chemical coloring product.

8. A method as claimed in claim 7, characterized in that said chemical coloring product is a glass-fusion color, a colored enamel, a ceramic pigment, or finely ground glass grit.

9. A method as claimed in claim 1, characterized in that said step of baking said glass bar (5) comprises the step of placing the glass bar (5) on a supporting panel for preventing buckling of the glass bar (5) during baking.

10. A method as claimed in claim 1, characterized by comprising the step of sanding said glass bar (5).

11. A system (1) for producing ornamental glass strips, characterized by comprising shaping means (6) for removing glass from at least one surface portion (5a) of a glass bar (5), so as to impart to the glass bar a predetermined ornamental profile; and baking means (10) for heat treating said glass bar (5).

12. A system as claimed in claim 11, characterized by comprising enameling means (9) for applying a chemical glass-processing product to said glass bar (5).

13. A system as claimed in claim 11, characterized in that said chemical glass-processing product is an antidevitrification enamel for restoring said shaped portion (5a) of said glass bar (5).

14. A system as claimed in claim 11, characterized in that said chemical glass-processing product is a dulling enamel for imparting a satiny finish to said shaped portion (5a) of said glass bar (5).

15. A system as claimed in claim 11, characterized by comprising glass-cutting means (3) for cutting a sheet of glass (4) into a succession of glass bars (5).

16. A system as claimed in claim 11, characterized by comprising glass-cutting means (11) for cutting a portion of predetermined length off the two ends of said glass bar (5).

17. A system as claimed in claim 11, characterized by comprising painting means (7) for applying a chemical coloring product to said glass bar (5).

18. A system as claimed in claim 17, characterized by comprising drying means (8) for drying said coloring product applied to said glass bar (5).

19. A system as claimed in claim 11, characterized by comprising satin-finishing means (12) for sanding said glass bar (5).

20. An ornamental glass strip (2), characterized by being produced using the method for producing glass strips or similar, as claimed in claim 1.
